(19) United States
(12) Patent Application Publication
(10) Pub. No.: US 2012/0216347 A1
(43) Pub. Date: Aug. 30, 2012

(54) Reciprocating Rocking Device

(76) Inventors: Vincent E. Tundo, Silver Creek, NY (US); Anthony W. Fini, JR., Blasdell, NY (US)

(21) Appl. No.: 13/228,866

(22) Filed: Sep. 9, 2011

Related U.S. Application Data
(60) Provisional application No. 61/446,261, filed on Feb. 24, 2011.

(51) Int. Cl. A47D 9/02; F16H 21/40; B62M 1/14; A47C 3/02

(52) U.S. Cl. 5/109; 297/260.1; 297/260.2; 74/25; 280/250.1

(57) ABSTRACT

A motorized apparatus that produces either rocking or gliding motion, includes a gear motor with a drive shaft; a drive mechanism to functionally connect to a device to be rocked; the drive mechanism being either an actuating linkage or an eccentric that is rotatably coupled to both said drive shaft and said device to be rocked or glided translating rotary motion of the drive shaft when powered to said drive mechanism, that translates the motion to said device to be rocked or glided providing continuously smooth rocking motion to any device that is enhanced by being able to be rocked or glided, such as a cradle, rocker, or wheel chair.

### CROSS-REFERENCE TO RELATED APPLICATIONS

This Non-provisional Application claims the benefit of Provisional Application No. 61/446,261 filed Feb. 24, 2011.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to devices for rocking a cradle, or the like and, more particularly, to a device that provides continuously smooth rocking or gliding of a wheelchair, rocking chair, a child's crib or any device on wheels or rockers that benefits from the continuously smooth reciprocating rocking or gliding motion provided by the device.

The background information discussed below is presented to better illustrate the novelty and usefulness of the present invention. This background information is not admitted prior art.

Recent studies demonstrate that a rocking motion, including gliding, is beneficial to both physical and mental health. Patients with mid-stage dementia often are often difficult to calm. Because these people are aware, to some extent, of what is happening to them, they often feel fear, anger and anxiety. A study sponsored by the School of Nursing of the University of Rochester found that the act of rocking released endorphins that calm and relax patients suffering from dementia. Researchers at the Medical College of Virginia found that one hour of a rocking-type motion per day provides relief to people suffering from arthritis and can help post-operative patients recover faster and suffer from fewer complications. Smooth repetitive motion also was shown to improve muscle tone and flexibility. Children with ADD and similar learning difficulties were reported to be able to concentrate while they are partaking of a rocking motion. Observations of patients made in the Orange Spine and Disc Rehabilitation Center in California led to conclude that the rocking motion of a rocking chair combined with some basic exercises help relieve chronic back pain. It is well known that that rocking helps to induce sleep, especially in infants. Such rocking, of course, may be provided by rocking an infant in a cradle instead of a rocking chair.

In addition to the therapeutic effects of rocking, many child care givers simply enjoy rocking an infant in a rocking chair. The time spent rocking can be a time of bonding for both a parent or caregiver and the child. Adults, of all ages, also enjoy the rocking motion provided by a rocking chair. Some people, young and old, may find themselves in a situation where a rocking chair or other rocking device is not available.

A wheelchair is a chair with wheels to provide mobility to those who cannot walk or for those who have difficulty walking. Wheelchairs can be propelled manually or by motors in a forward or sometimes backward motion. Everyday manual wheelchairs come in two major designs—folding or rigid. Many manual wheelchairs can be folded for storage or placement into a vehicle, although modern wheelchairs are just as likely to be rigid framed. Transport wheelchairs, designed to be pushed by a caregiver are built to be especially lightweight and are able to be easily folded. Rigid chairs have permanently welded joints and many fewer moving parts to reduce the energy required to push the chair. Rigid chairs typically feature instant-release rear wheels and backrests that fold down flat, allowing the user to dismantle the chair quickly for storage in a car. Many rigid models are now made with ultra-light materials such as aircraft aluminum and titanium making them easier to move.

Manual or self-propelled wheelchairs are designed to be propelled by the occupant, usually by turning the large rear wheels that are usually from 20-26 inches in average diameter, and resemble bicycle wheels. The user moves the chair by pushing on hand-rims, which are made of circular tubing attached to the outside of the large wheels. The hand-rims have a diameter that is slightly less than that of the rear wheels. Skilled users can control speed and turning and often learn to balance the chair on its rear wheels—do a “wheelie”. The wheelie is not just for show—a rider who can control the chair in this manner can climb and descend curbs and move over small obstacles.

One-arm drive enables a user to guide and propel a wheelchair from one side. Two hand-rims, one smaller than the other, are located on one side of the chair, left or right. On most models the outer, or smaller rim, is connected to the opposite wheel by a folding axle. When both hand-rims are grasped together, the chair may be propelled forward or backward in a straight line. When either hand-rim is moved independently, the chair will turn left or right in response to the hand-rim used. Another alternative is a LeverDrive chair that propels the chair forwards by using a lever that is pumped back and forth. Some chairs are also configured to allow the occupant to propel using one or both feet instead of using the rims.

Attendant-propelled chairs are designed to be manipulated by an attendant using the handles positioned on the rear of the chair, and thus the back wheels are rimless and often smaller. These chairs are often used as ‘transfer chairs’ to move a patient when a better alternative is unavailable, possibly within a hospital, as a temporary option, or in areas where a user's standard chair is unavailable.

Experiments have also been made with unusual variant wheels, such as the mecanum wheel, which is a wheel that can move in any direction and is sometimes called the lion wheel after its Swedish inventor, Bengt lion, or the omniwheel similar to mecanum wheel, have small discs around their circumference which are perpendicular to the rolling direction. The effect is that the wheel will roll with full force, but will also slide laterally with great ease. These wheels allow for a broader spectrum of movement. An electric wheelchair fitted with mecanum wheels provide for complete freedom of movement. The chair can be driven forwards, backwards, sideways, and diagonally, and also turned round on the spot or turned around while moving, all operated from a simple joystick.

Various optional accessories are available, such as anti-tip bars or wheels, safety belts, adjustable backrests, tilt and/or recline features, extra support for limbs or neck, mounts or carrying devices for crutches, walkers or oxygen tanks, drink holders, and clothing protectors.

To accommodate special needs persons, there are wheelbase chairs that are wheeled platforms with specially-molded seating systems for users with a more complicated posture needs. A molded seating system involves taking a cast of a person's best achievable seated position and the either carving the shape from memory foam or forming a plastic mesh around it. This seat is then covered, framed, and attached to a wheelbase.

Light weight, manual wheelchairs are usually the highest in cost. At the low-cost end, wheelchairs are heavy, constructed from tubular steel, have sling style seats, and little adaptability. Users of these chairs may be temporarily disabled and do not want to invest in a higher end chair, or may be using such a chair as a loaner, or simply are unable to afford the higher-end chairs. Higher-end chairs are ultra-light, have extensive seating options and accessories, all-terrain features, and so forth. Reclining wheelchairs have handbrake-like controls attached to the push handles or posts supporting the backrest which, when pressed by the caregiver, allow the backrest to recline from is normal upright position (at 90 degrees) to varying angles up to 180 degrees.

An electric-powered wheelchair is moved via the means of an electric motor and navigational controls, usually a small joystick mounted on the armrest, rather than manual power. For users who cannot manage a manual joystick, head switches, chin-operated joysticks, sip-and-puff or other specialist controls may allow independent operation of the wheelchair. A mobility scooter (see full article) is a motorized assist device similar to an electric-powered wheelchair, but with a steering ‘tiller’ or bar instead of the joystick, and fewer medical support options. Mobility scooters are available without a prescription in some markets, and range from large, powerful models to lightweight folding ones intended for travel. A bariatric wheelchair is one designed to support larger weights; most standard chairs are designed to support no more than 250 lbs. on average. Pediatric wheelchairs are another available subset of wheelchairs. Hemi wheelchairs have lower seats which are designed for easy foot propulsion. The decreased seat height also allows them to be used by children and shorter individuals.

A Power-Assisted wheelchair is a recent development that uses the frame and seating of a typical manual chair while replacing the standard rear wheels with wheels that have small battery-powered motors in the hubs. A floating rim design senses the pressure applied by the users push & activates the motors proportionately resulting in the convenience, small size & light-weight of a manual chair while providing motorized assistance for rough/uneven terrain & steep slopes that would otherwise be difficult or impossible to navigate, especially by those with limited upper-body function.

Disabled athletes use sport wheelchairs that require speed and agility, such as basketball, rugby, tennis, and racing. Each wheelchair sport tends to use specific types of wheelchairs, and these no longer look like their everyday cousins. They are usually non-folding (in order to increase rigidity), with a pronounced negative camber for the wheels (which provides stability during a sharp turn), and made of composite, lightweight materials. Sport wheelchairs are not generally for everyday use, and are often a ‘second’ chair specifically for sport use, although some users prefer the sport options for everyday.

All-terrain wheelchairs allow users to enter the water and provide a better mobility in the sand and on uneven terrain. There are lots of different models available both manual and battery driven.

Recent technological advances are slowly improving wheelchair and electric powered wheelchair technology. Some wheelchairs, such as the iBOT, incorporate gyroscopic technology and other advances, enabling the chair to balance and run on only two of its four wheels on some surfaces, thus raising the user to a height comparable to a standing person. They can also incorporate stair-climbing and four-wheel-drive feature motorized assists for hand-powered chairs are becoming more available and advanced. The popular Segway Personal Transporter is a mobility device that was a direct outgrowth of the development of the iBOT wheelchair. The Segway, which is basically an iBOT with two wheels removed, was developed explicitly to increase the number of units produced and take advantage of the economies of scale to make the iBOT affordable to wheelchair users. The $25,000 iBot, which was developed as a joint venture between Johnson and Johnson's Independence Technology and Dean Kamen's DEKA Research, was discontinued in January 2009. The addition of geared, all-mechanical wheels for manual wheelchairs is a new development incorporating a hypocycloidal reduction gear into the wheel design. The 2-gear wheels can be added to a manual wheelchair. The geared wheels provide a user with additional assistance by providing leverage through gearing (like a bicycle, not a motor). The two-gear wheels offer two speed ratios—1:1 (no help, no extra friction) and 2:1, providing 100% more hill climbing force. The low gear incorporates an automatic “hill hold” function which holds the wheelchair in place on a hill between pushes, but will allow the user to override the hill hold to roll the wheels backwards if needed. The low gear also provides downhill control when descending.

### SUMMARY

The present inventors recognized that there are many instances where the soothing and therapeutic effects provided by smoothly continuous repetitive motions such as rocking and gliding would be appreciated by and used to the advantage by those who do not have the ability or opportunity to rock themselves, such as infants in cradles and persons who are confined to a wheel-chair, as well as by people enjoying the comfort of a rocking chair. And although, as was shown above, wheelchairs can be propelled forward and backward, there is no wheelchair that can provide the smooth rocking or gliding motion of a rocker or glider.

Accordingly, the present inventors teach an inventive concept that provides the means and method to provide for a powered, continuously smooth rocking or gliding motion when used in combination with items that rock on rockers, such as a rocking chair or cradle, or a wheeled device, such as a wheelchair. The inventive concept is to provide a rocking chair or cradle, items that have only two points of connection with their supporting surface, with an engine, such as a rotary motor, in conjunction with a cam or an eccentric to overcome the dampening force caused by the weight carried in the rocking chair or cradle to provide a continuously smooth rocking motion to the rocking chair or cradle and that enables the rocking chair or cradle to maintain its continuously smooth rocking or gliding motion until it is desired to stop the motion. The inventive concept also contemplates providing the same type of engine, such as a rotary motor, in conjunction with a cam or an eccentric, rotatably connected to a wheeled device, such as a wheelchair, also by using an engine, such as a rotary motor, to overcome the dampening force caused by the weight carried in the wheelchair so as to provide a continuously smooth gliding motion to the chair and, further, enables the chair to maintain its continuously smooth gliding motion until it is desired to stop the motion. In one example, the engine is a rotary motor having connecting rod(s) that make up a mechanical linkage, which as used herein, translates the input rotary motion of the motor to a reciprocating output of smooth continuous motion. The rotary motor powers the rotary motion, such as when an automobile engine produces crankshaft rotary motion. The linkage, attached on one end to the rotary motor, provides for the rotary motion of the motor to be translated into a reciprocating motion that is used to provide either a smooth rocking motion to a cradle or a gliding motion to a wheelchair, for example. In another example, a rotary motor powers rotational motion to an eccentric to translate the continuously smooth input rotary motion of the motor to a continuously smooth rotation of the eccentric that provides continuously smooth motion to a cradle, a rocker, or a wheelchair. The wheelchair may further be enhanced by the addition of a footrest that is designed to provide a range of extensional/compressional movement for a user's legs, which is important from a therapeutic point of view.

This reciprocating motion system is to be differentiated from the reciprocating motion produced by a motor vehicle's engine where the motor sets the vehicle's pistons in a reciprocating motion that is then translated to the rotary motion of a crankshaft that in turn moves the wheels of the vehicle. The reciprocating motion of the present invention should also be differentiated from the reciprocating motion produced by linear motion actuators that include worm gear or rack and pinion types. The motion produced by costly linear motion actuators is not desired because they produce a short pause after each direction stroke much like that of a windshield wiper motor mechanism causing an interrupted, uneven motion. Although there are devices that can impart a motion that simulates a reciprocal motion to, for example, a cradle, the motion is not a true, smooth, continuous motion, and thus does not impart the relaxation that the present invention does.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a perspective view of one example of the device of the present invention being used to provide a smooth rocking motion to a cradle.

FIG. 2 is an elevation side view illustrating the device attached to the underside of the cradle and to the top of the cradle's base, as shown in FIG. 1.

FIG. 3 is an elevational, close-up, transparent view of one example of how the cradle, as shown in FIG. 1, may be attached to its base.

FIG. 4 is a side elevational view of another example of the invention as it may be used as a wheel-chair glider.

FIG. 5 is a close-up cut-out view of one of the ball bearing rollers of the device and how it is placed in the guide rails.

FIG. 6 is a plan view of the base of the device when used to provide gliding motion to a wheelchair.

FIG. 7 is a perspective view of an example of a device of the present invention.

FIG. 8 is an elevational view of another version of a rotary gear motor producing a reciprocal motion that is translated to a rocking device.

FIG. 9 is an elevation view of a device according to the principles of the present invention providing a continuously smooth rocking motion to a cradle.

FIG. 10 is an elevation view of a device according to the principles of the present invention providing a continuously smooth rocking motion to a rocking chair.

FIG. 11 is a view of a foot-support attached to a gliding-motion wheelchair.

### A LIST OF REFERENCE CHARACTERS AND PARTS TO WHICH THEY REFER

1 Cradle.
2 Base.
3 Rockers.
4 Bolt.
5 Metal washer.
6 Compressible washer.
7 Acorn nut.
8 Mounting bracket for gear motor.
9 U-Shaped drive bracket.
10 Present invention device to provide reciprocating rocking or gliding motion.
10e Gear motor in gear motor housing.
11 Eccentric cam.
12 Linkage actuator.
12a Arm of linkage actuator 12.
12b Arm of linkage actuator 12.
12c Arm of linkage actuator 12.
13 Notch in rocker 3 of cradle 1.
14 Gear motor housing.
16 Ball bearing roller.
18 Guide rails.
20 Base frame of wheelchair glider device.
30 Double linkage actuator device.
100 Cradle.
102 Rocker.
104 Bottom or floor of cradle 100.
106 Top surface of base.
108 Base.
110 Attachment.
112 Dowel connector.
114 Support plate (a washer, for example).
116 Cotter pin.
118 Accommodating notch.
202 Wheelchair caster wheel.
204 Structural flats to connect drawbars 204.
205 Drawbars.
210 Space between two of the three drawbars 205.
214 Thumbscrews.
215 Caster wheel guides.
220 Ramp.
250 Protective cover.
1b Chair.
2b Base.
3b Rockers.
4b Bolt.
5b Metal washer.
6b Compressible washer.
7b Acorn nut.
8b Mounting bracket for gear motor.
9b U-Shaped drive bracket.
10b Gear motor.
11b Eccentric cam.
13b Gear motor drive shaft.
14b Optional tension adjustment rod.
12d V-Notch.
1e Rocking chair.
2e Base.
3e Rocker.
4e Bolt.
5e Steel washer.
6e Spring.
7e Acorn nut with washer.
8e Mounting bracket for gear motor.
9e Mounting bracket for wheel.
10e Gear motor.
11e Eccentric (cam).
12e Wheel.
13e V-notch.
20e Points of contact of wheelchair with floor.
1f Foot rest.
2f Heel catch.
3f Mounting brackets.
4f Angle adjustment for footrest 1f.
5f Height adjustment for footrest 1f.
6f Lock pin for height adjustment 5f.
7f Base clamp.
8f Optional hook and loop connecting straps.

### DEFINITIONS

Cam, as used herein, is a rotating or sliding piece in a mechanical linkage used especially in transforming rotary motion into linear motion or vice-versa. It is often a part of a rotating wheel (e.g. an eccentric wheel) or shaft (e.g. a cylinder with an irregular shape) that strikes a lever at one or more points on its circular path. The cam can be a simple tooth, as is used to deliver pulses of power to a steam hammer, for example, or an irregular shaped disc, or other shape that produces a smooth reciprocating (back and forth) motion in the follower, which is a lever or a wheel making contact with the cam. The most commonly used cam is cut out of a piece of solid material, such as metal. Here, the follower moves in a plane perpendicular to the axis of rotation of the camshaft. Several key terms are relevant in such a construction of plate cams: base circle, prime circle (with radius equal to the sum of the follower radius and the base circle radius), pitch curve which is the radial curve traced out by applying the radial displacements away from the prime circle across all angles, and the lobe separation angle (LSA—the angle between two adjacent intake and exhaust cam lobes).

Eccentric, as used herein, is a circular disk solidly fixed to a rotating shaft with its shaft receiving aperture offset from center (hence the word “eccentric”, out of the center).

Moment or moment of force, also called torque, as used herein, refers to the tendency of a force to move an object about an axis, fulcrum, or pivot.

Rocking chair or rocker, as used herein, refers to a type of chair with two curved bands of wood (also known as rockers) attached to the bottom of the legs (one on the left two legs and one on the right two legs). The chair contacts with the floor at only two points, giving the occupant the ability to rock back and forth by shifting his/her weight or pushing lightly with his/her feet. Many find rocking chairs soothing because of the gentle motion. Rocking chairs are also comfortable because, when a user sits in one without rocking, the chair automatically rocks backwards until the sitter's center of gravity is met, thus granting an ergonomic benefit with the occupant kept at a very unstressed position and angle. Varieties of rockers include those mounted on a spring base (or platform) called “platform rockers” and those with swinging braces commonly known as gliders.

Simple machine, as used herein, refers to a mechanical device that changes the direction or magnitude of a force. In general, they can be defined as the simplest mechanisms that use mechanical advantage (also called leverage) to multiply force. A simple machine uses a single applied force to do work against a single load force. Ignoring frictional losses, the work done on the load is equal to the work done by the applied force.

Wheel, as used herein, refers to a circular device that is capable of rotating on an axle through its center, facilitating movement or transportation while supporting a load (mass), or performing labor in machines. The wheel enables efficient movement of an object across a surface where there is a force pressing the object to the surface. A wheel, together with an axle (also referred to as shaft or drive shaft), overcomes friction by facilitating motion by rolling. Common examples are a cart pulled by a horse and a wheelchair. In order for wheels to rotate, a moment needs to be applied to the wheel about its axis, either by way of gravity, or by application of another external force. The low resistance to motion (compared to dragging) is due to the fact that while the normal force at the sliding interface is the same for an object being dragged and the object on wheels, the sliding distance of the object using wheels and axel is reduced for a given distance of travel, and the coefficient of friction at the interface is usually lower.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention follows the principles of inventive concept described herein that provide for the invention to be disposed to embodiments in various sizes, shapes, and forms, for use with differently sized, shaped, or forms of rocking or gliding devices, such as, chairs, cradles, or wheelchairs. For example, the size of the present invention, which may be thought of as a simple machine that provides a force to move an object about an axis, fulcrum, or pivot, could change depending, for one, on the power of the motor required to provide the desired motion. Moreover, motors come in many different shapes depending on size, power, and use and therefore there is likely to be many shapes for the motor of the present invention. The form of the invention also depends on if the motor control is to be attached between a cradle or the like and the base of the cradle, a wall and a wheelchair, if the motor is supported by a stand that is provided for that use, is attached directly to a wheelchair, or is attached to a base to support a wheelchair, for example. Moreover, the motor and related mechanism might be attached to the front, side, or back part of a wheelchair or be a remotely controlled device. Therefore, the embodiments as described herein are provided with the understanding that the present disclosure is intended as illustrative and is not intended to limit the invention to the embodiments described herein.

The present Inventors realizing that despite all of the advances made to wheelchairs, there was still no way for a wheelchair bound person to enjoy a back and forth rocking or gliding chair motion without someone physically turning the wheels of the chair back and forth manually. Some wheelchair users, however, are physically incapable of partaking in such an activity, some are too weak to indulge themselves for any substantial length of time, and some simply do not want to exert the considerable effort this manually-powered motion requires. Accordingly, the Inventors developed a set of inventive principles to provide wheelchair bound persons with a way to effortlessly enjoy rocking in their wheelchair. Basically, these principles require a motor, such as a gear motor, for example, and a drive mechanism that includes an actuating linkage or an eccentric to translate the typically rotary motion of a motor to a reciprocating motion to impart a smooth back and forth rocking or gliding motion to a wheelchair. Thus, the present invention is directed towards a motor having a rotating shaft that is attached to an actuating linkage or an eccentric that is, in turn, attached to a wheelchair for the purpose of translating the rotary motion of the motor into a reciprocating motion of the wheelchair providing for the wheelchair to be continuously and smoothly moved back and forth at a pace that is relaxing to the user who cannot, or does not want to, self-propel. Additionally, there is an on/off and a speed control that may be remote or may be within the grasp of the occupant of the wheelchair.

In another exemplary embodiment of the present invention, a motor, such as a gear motor, for example, has a rotating shaft that is rotably attached to a drive mechanism that includes an actuating linkage or an eccentric that is attached to a cradle for the purpose of translating the rotary motion of the motor into a reciprocating motion providing for the cradle to be continuously and smoothly rocked back and forth without the need for manual rocking by the parent/caregiver of the child. The cradle includes a frame assembly configured to receive the cradle in a releasable secured fashion. The frame assembly includes a base to support the cradle, such as supporting the cradle on a floor, and attachments to attach the cradle to the base. Disposed within the frame assembly, that is attached to and between the cradle and the cradle's base is the reciprocating rocking device of the present invention, configured to provide a rocking motion to the cradle. The apparatus has the flexibility of being attached to a variety of commercially available cradles or the like. The apparatus operates by a non-complex, low cost mechanism. The apparatus is safe, economical, simply constructed, and easily repaired.

In yet another exemplary embodiment of the present invention, a motor, such as a gear motor having a rotating shaft that is attached to an eccentric that is contained in and acting in concert with and upon a linkage or housing bracket, which may be a U-shaped drive bracket that is attached to a cradle for the purpose of translating the rotary motion of the motor to the rotation of the eccentric that in concert with the U-shaped drive bracket provides continuously smooth back and forth rocking motion without the need for manual rocking by the parent/caregiver of the child. The cradle includes a frame assembly configured to receive the cradle in a releasable secured fashion. The frame assembly includes a base to support the cradle, such as supporting the cradle on a floor, and attachments to attach the cradle to the base. Disposed within the frame assembly, that is attached to and between the cradle and the cradle's base is the rocking device of the present invention. The apparatus has the flexibility of being attached to a variety of commercially available cradles or the like. The rocking assembly is a non-complex, low cost mechanism and is safe, economical, simply constructed, and easily repaired. The gear motor may, or may not, be attached to the device to be rocked or glided and may be powered by any means desired, electrical power AC, DC, or battery, solar, or other, for example.

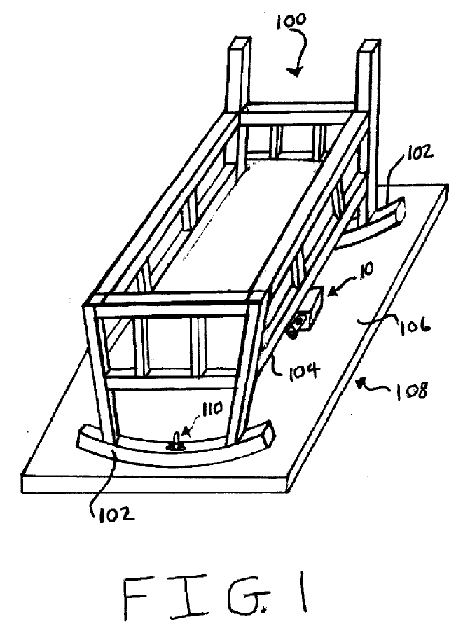

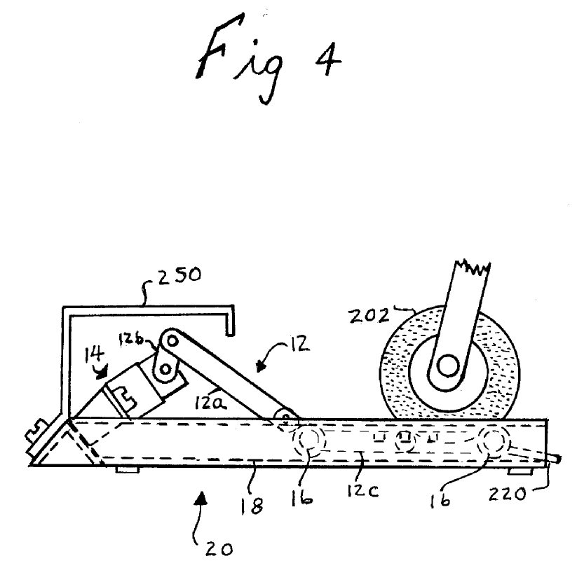

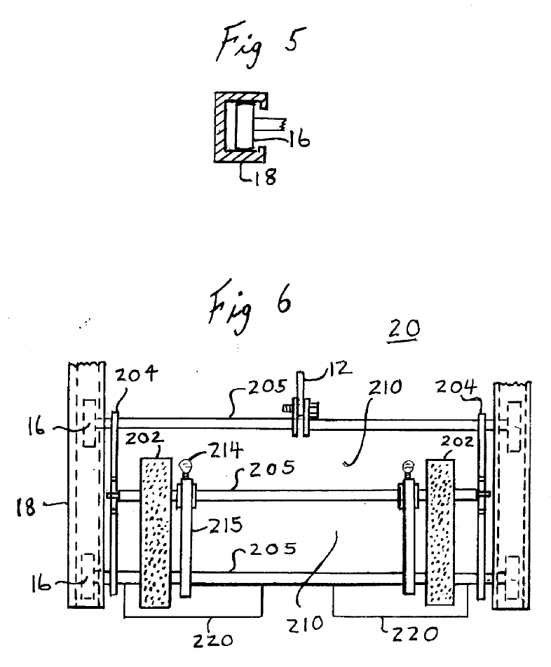

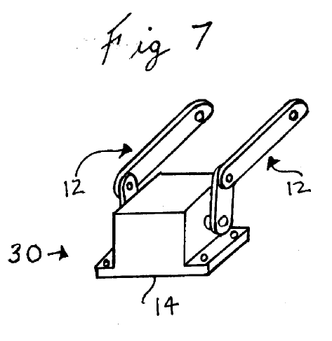

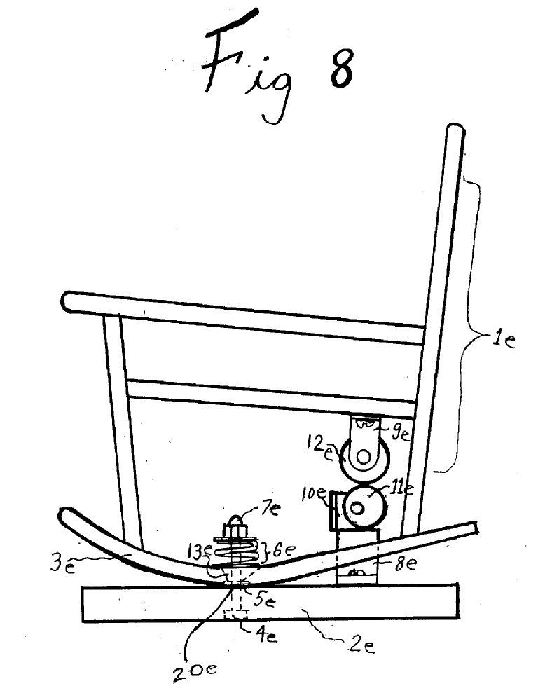

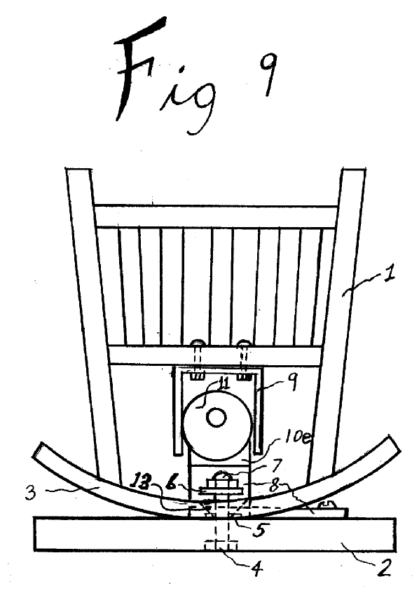

Turning now to the drawings, FIG. 1, a perspective view, illustrates one embodiment of the present invention. In this embodiment, motorized reciprocating motion device 10 is adapted to provide a reciprocating rocking motion for a cradle. Cradle 100 has a head board, a foot board, two sides, bottom portion 104, rockers 102, and cradle floor support base 108. In this example, cradle 100 is detachably attached to base 108. FIG. 3 further illustrates the details of attachment 110, which includes connector 112 extending into notch 118 and support plate 114 through the thickness of each rocker 102 (one rocker and its attachment are not visible in this view but are functionally identical) into base 108 to attach cradle 100 to the base. Notch 118 should be cut so that the angle of the notch is comparable to the maximum rocking degree. In this example, cotter pin 116 serves the important purpose of allowing the cradle to be lifted and moved along with its base while being kept securely connected to the base. Instead of a cotter pin, there are many other ways of maintaining the cradle/base connection, such as having pin 112 threaded to accept an acorn nut and washer, for example.

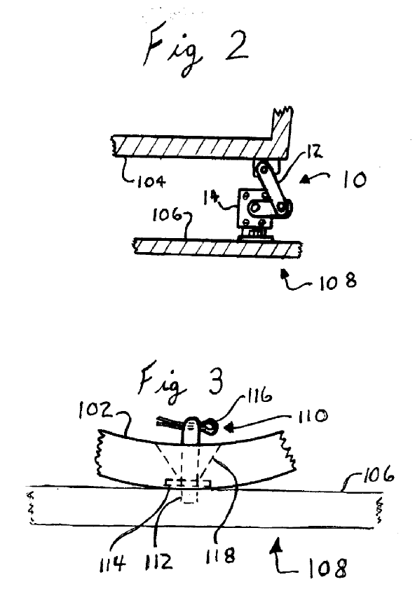

FIG. 2, an elevation side view, illustrates reciprocating motion device 10 attached to the underside of bottom cradle portion 104 and to top surface 106 of cradle's base 108, as shown in FIG. 1. Housed in housing 14 is a gear motor. Gear motors are well understood. A gear motor can be described simply as a machine having two or more gears working in tandem to translate the speed, magnitude, and direction of a power source to another device to produce a mechanical advantage. The most common example of gear motors is the motor that runs ordinary motor vehicles where the transmission (the gear system) adapts the output of the internal combustion engine (the reciprocating motion of the pistons) to the drive wheels (rotary motion). In this example of the present invention, the Inventors convert the rotary motion produced by a gear motor to a reciprocating motion to produce a continuous, smooth rocking or gliding motion to a cradle, or other device to be rocked. This is accomplished by functionally coupling the rotary output (drive shaft) of the gear motor to actuating linkage 12 that is designed to translate the rotary motion of the gear motor to a reciprocating motion that enables the item to which actuating linkage 12 also connected to exhibit a powered smooth, continuous reciprocating rocking or gliding motion. The weight of the cradle and its contents resting on the rockers seek equilibrium and, thus, provide a counterforce to any rocking motion. The reciprocating motion device 10 that is attached to and between bottom cradle portion 104 and top surface 106 of base 108 overcomes the counterforce to rocking to produce a smooth, continuous rocking movement. Alternatively, it could be said that reciprocating motion device 10 provides the energy required to maintain the rocking motion in a continuous manner.

In addition to providing smooth, continuous reciprocating motion to cradles, cribs, bassinets, and the like, following the inventive concept of the invention, motion device 10 is also designed to provide smooth, continuous reciprocating motion to those who must be in a wheelchair. FIG. 4, a side elevational view, illustrates an example of how the invention is used to provide a smooth, continuous reciprocating motion to a wheel-chair. As discussed above, wheelchairs are provided with rear weight bearing wheels and front steering or caster wheels. In FIG. 4 steering wheels or caster wheels 202 are illustrated supported by exemplar base frame 20. Steering wheels 202 of the wheel chair are smoothly and easily rolled onto base frame 20 using wheel ramps 220. Base frame 20 of device 10 provides support for both gliding motion device 10 and steering wheels 202 of a wheelchair. In this example, housing 14 provides a container for rotary motion gear motor (not shown as gear motors are well known in the art). Arms, 12a, 12b, and 12c, of actuating linkage 12 are rotably connected to the drive shaft of rotary motion gear motor and to each other forming actuating linkage 12. Actuating linkage 12 is designed to translate the rotary motion of the gear motor to a reciprocating motion to provide a powered, smooth, continuous reciprocating rocking or gliding motion to the wheelchair. How reciprocating motion of device 10 is used to provide a smooth, continuous reciprocating rocking or gliding motion to a wheelchair is best describe by the illustration and related discussion of FIG. 6. It should be appreciated that the number of linkage arms required are reduced when the motion inducing linkage arms are replaced by with an eccentric as is discussed in more detail below, in conjunction with FIGS. 8, 9, and 10.

FIG. 5, a close-up cut-out view, illustrates one of the ball bearing rollers 16 of base frame 20 of the present invention and how roller bearings 16 are positioned in the guide rails of track 18.

FIG. 6, a plan view, together with FIG. 4, illustrates how to make and how to use glider device for a wheel chair according to the concept of the present invention. Spaced support drawbars 205 are connected to each other by structural flat bars 204. Each end of each of the two outer drawbars 205 is attached to one of roller bearings 16 that are held securely within the confines of guide tracks 18 that are formed within the structure of base frame 20. This connection allows the motor/linkage combination to provide a gliding motion to a wheelchair once the wheel chair wheels 202 are positioned in space 210. One end of linkage 12 is rotably attached to the gear motor, which is supported on the bottom cross-wise portion of base frame 20, with the other end of linkage 12 being fixedly attached to drawbars 205. To use the present invention to provide gliding motion to a wheelchair, steering wheels 202 of the wheelchair are positioned within space 210 between the spaced drawbars 205 of base frame structure 20. FIGS. 4 and 6 illustrate how the power rotation of the drive shaft of the gear motor is translated into the smooth, continuous, reciprocal motion that is conveyed to roller bearings 16 that are supported by and move within track 18 of base frame 20 and ultimately to a wheelchair supported by base frame 20. Steering wheels 202 of the wheelchair, using wheel ramps 220, are smoothly and easily rolled onto base frame 20 where they are securely positioned within space 210 that is between drawbars 205. Because wheels 202 are the steering wheels of the wheelchair, they are made to easily turn or caster. To keep the wheels from castering to the point that could cause them to slip into space 210 between two of the drawbars 205, especially the central drawbar 205 and drawbar 205 from which wheel ramps 220 extend. Base frame 20 of device 10 is provided with adjustable caster (steering) wheel guides 215. In this example, thumbscrews 214 are used to loosen and tighten adjustable caster wheel guides 215 about drawbars 205. By loosening thumbscrews 214, caster wheel guides 215 may be spacedly adjusted to provide for different dimensions of the wheel base of different wheelchairs, as the wheel base can range from about 15 to 30 inches wide. Adjustable caster wheel guides 215 can be set so that they will be close to the inside surface of wheels 202 restricting the degree that the wheels can turn. Smooth gliding motion of the wheel chair is provided by roller bearings 16 that are firmly seated within the guide rails of tracks 18. Roller bearings 16 are fixedly attached to outer draw bars 205 upon which linkage arm 12c of linkage 12 is fixedly attached. When power is provided to the rotary motor, the working of linkage 12 conveys a smooth, continuous gliding motion for base frame 20 via its connection to drawbars 205. Drawbars 205 are easily moved forward and backward due to the decrease in friction made possible by roller bearings 16. As the drawbars 205 are propelled in a forward and reverse motion, the wheelchair whose caster wheels are supported on the drawbars of base frame 20 is gently, continuously, and smoothly moved in a reciprocating motion by the action of the rotary motor and its linkage. Because the weight of the occupant is centered over the rear supporting wheels of a wheelchair, the chair can be moved easily even by a relatively low-powered motor, such as a 7.5 amp motor.

FIG. 7, a perspective view, illustrates an example of gliding/rocking motion producing device 30 according to the principles of the present invention fitted with dual actuating linkages 12 providing for powered motion to be delivered from both sides of the motor where required.

FIG. 8, an elevational view, illustrates a gliding/rocking motion producing device comprised of a rotary gear motor functionally connected to an eccentric cam, which is another way for the invention according to the inventive concept to produce a reciprocal motion that is translated to, in this example, rocking chair 1e. Alternatively, a rotary gear motor and an eccentric cam can produce a reciprocal motion that is translated to a cradle or to a wheeled device, such as a wheelchair or baby's carriage. As rocker chair 1e rocks, each of its rockers 3e has a single point of contact 20e with the rocker chair's support, base 2e. In this example, bolt 4e, washer 5e, and acorn nut with washer 7e securely attach rockers 3e of rocker 1e to base 2e. V-notch 13e, that is in each of the two rockers, provides for unimpeded oscillation or rocking of rockers 3e about bolt 4e without damaging the rockers. In other words the notch provides space for the rockers to oscillate about the bolt without stressing the rockers. Compressional spring 6e is one way to secure the points of contact of rockers 3e to base 2e. Powered rocking motion is provided by gear motor 10e secured to base 2e by mounting bracket 8e. The rotary motion produced by gear motor 10e is translated to smooth, continuous, reciprocal motion by eccentric 11e. As eccentric 11e is caused to rotate by gear motor 10e its eccentric shape causes wheel 12, attached to the seat of the rocker 1e by mounting bracket 9e, to turn. As the maximum length diameter of eccentric 11e contacts wheel 12e it lifts the seat of rocker 1e and as the minimum length diameter contacts wheel 12e it allows the seat of the rocker to lower. Gear motor 10e is contemplated to be powered by a variety of power sources, such as, in-house electricity, a battery, or solar energy.

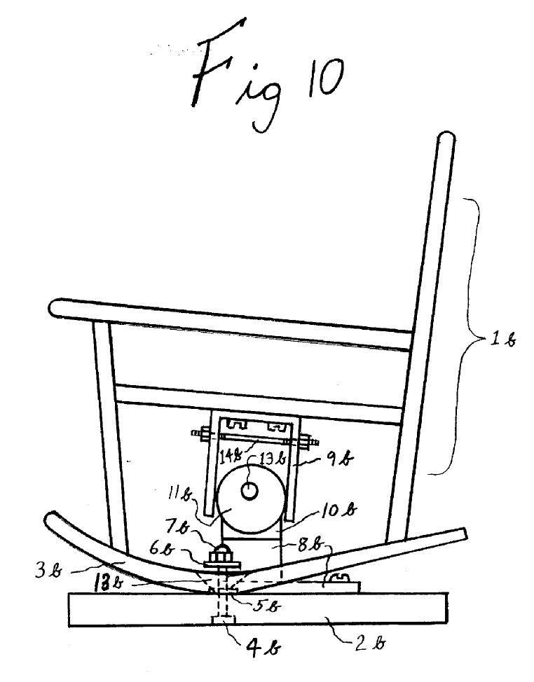

FIG. 9 is an elevation view of a motorized-rocker cradle according to the principles of the present invention. Cradle 1 with rockers 3 sits on and, in this example, is attached to base 2 using bolt 4, washer 5, and acorn nut 7 with washer 6. V-notch 13, that is a part of each of the two rockers, provides for unimpeded oscillation or rocking of rockers 3 about bolt 4 without damaging the rockers. In other words the notch provides space for the rockers to oscillate about the bolt without stressing the rockers. The motorized rocking device includes a gear motor housed within gear motor housing 10e and attached to the cradle's base via mounting brackets 8. The drive shaft (rotary output) of the gear motor is functionally coupled to eccentric 11 to translate the rotary motion of the gear motor to U-shaped mounting/drive bracket 9 that is fixedly connected to the bottom of cradle 1 to provide a powered continuously smooth, rocking motion to the cradle when the power is turned on. Gear motors are well understood and will not be discussed further here. The weight of the cradle and its contents resting on the rockers seek equilibrium and, thus, provide a counterforce to any rocking motion. The continuously smooth rocking motion device that is attached to and between bottom cradle portion and top surface of base 2 overcomes the counterforce to rocking to produce a smooth, continuous rocking movement.

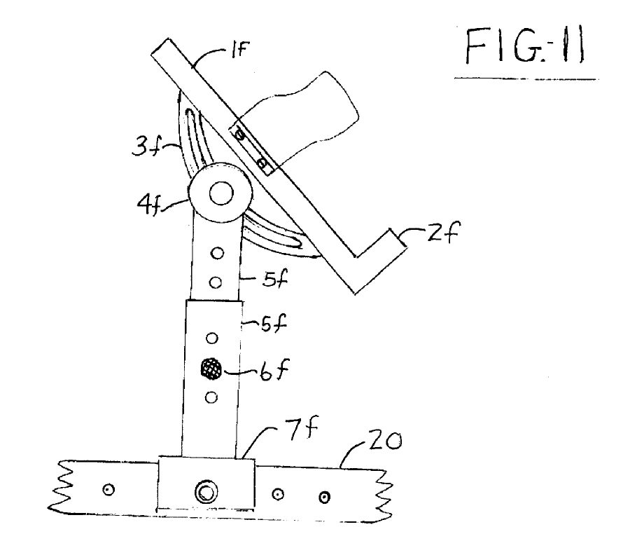

FIG. 10 is a side elevation view of a device according to the principles of the present invention providing a continuously smooth rocking motion to a rocking chair. Rocking chair 1b with rockers 3b sits on and, in this example, is attached to base 2b using bolt 4b, washer 5b, and acorn nut 7b with washer 6b. V-notch 13b, that is a part of each of the two rockers 3b, provides for unimpeded rocking of rockers 3b about bolt 4b without damaging the rockers. In other words the notch provides space for the rockers to oscillate about the bolt without stressing the rockers. The motorized rocking device includes a gear motor housed within gear motor housing 10b and attached to the rocker's base via mounting brackets 8b. The drive shaft (rotary output) 13b of the gear motor is functionally coupled to eccentric 11b to translate the rotary motion of the gear motor to U-shaped mounting/drive bracket 9b that is fixedly connected to the bottom of rocking chair 1b to provide a powered continuously smooth, rocking motion to the rocking chair when the power is turned on. Gear motors are well understood and will not be discussed further here. The weight of the rocking chair and its contents resting on the rockers seek equilibrium and, thus, provide a counterforce to any rocking motion. The continuously smooth rocking motion device that is attached to rocking chair 1b overcomes the counterforce to rocking to produce a smooth, continuous rocking movement.

FIG. 11 is a view of a footrest that can be attached to a gliding-motion wheelchair and following the principles of the present invention comprises a footrest surface 1f upon which a user's feet are to rest and a heel stop 2f to prevent the user's feet from slipping off of footrest surface 1f. Footrest surface 1f is connected to and supported by angel adjustment 3f that provides for the footrest to be angled as desired for a user's comfort by angle adjustment 3f rotably attached to footrest surface 1f via attachment mechanism 4f that is securely attached to the height adjustment brace columns 5f. The two height adjustment brace columns 5f serve to support angle adjustment 3f and to adjust the height of footrest surface 1f. In the example illustrated, one of the two height adjustment brace columns 5f is sized to slide-ably fit within the other column so that as the inner column is raised out of its containing outer column, the height of the footrest is raised and, conversely, as the inner column is lowered into its containing outer column, the height of the footrest is lowered. To maintain the desired height, stopper 6f is inserted into the aligned apertures of each column when the desired height has been attained. The containing outer column is secured to base 20 of a gliding/rocking motion producing device by mounting bracket 7f.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A motorized apparatus producing rocking or gliding in a device, comprising:
a gear motor with a drive shaft;
a drive mechanism functionally coupled to a device to be rocked glided;
an eccentric rotatably coupled to both said drive shaft and said drive mechanism, said eccentric translating rotary motion of the drive shaft of the gear motor when powered to said drive mechanism, and said drive mechanism translating continuously smooth rocking or gliding motion to said device.

2. The apparatus, as recited in claim 1, wherein said drive mechanism is a drive bracket.

3. The apparatus, as recited in claim 1, wherein said gear motor is to be fixedly attached to a base of said device to be rocked.

4. The apparatus, as recited in claim 1, wherein said device to be rocked or glided is a wheel chair.

5. The apparatus, as recited in claim 4, wherein said device to be rocked is a cradle with rockers that are attached to a base piece with an attachment device.

6. The apparatus, as recited in claim 5, wherein said drive mechanism is a U-shaped drive bracket fixedly connected to the bottom of the cradle.

7. The apparatus, as recited in claim 6, wherein said eccentric is housed within said U-shaped drive bracket.

8. The apparatus, as recited in claim 5, wherein said rockers have a notched center, said notch cut so that the angle of the notch is comparable to the maximum rocking degree providing space for the rockers to oscillate about the bolt without stressing the rockers.

9. The apparatus, as recited in claim 5, further includes a gear motor housing attached to the cradle's base via mounting brackets in which said gear motor is housed.

10. The apparatus, as recited in claim 1, wherein said device to be rocked is a rocking chair with rockers that are attached to a base piece with an attachment device.

11. The apparatus, as recited in claim 10, wherein said drive mechanism is a U-shaped drive bracket fixedly connected to the bottom of the rocking chair.

12. The apparatus, as recited in claim 11, wherein said eccentric is housed within said U-shaped drive bracket.

13. The apparatus, as recited in claim 12, wherein said rockers have a notched center, said notch cut so that the angle of the notch is comparable to the maximum rocking degree providing space for the rockers to oscillate about the bolt without stressing the rockers.

14. The apparatus, as recited in claim 13, further includes gear motor housing attached to the rocking chair's base via mounting brackets in which said gear motor is housed.

15. A motorized apparatus used in conjunction with a device to be rocked or glided, comprising:
a gear motor with a drive shaft;
a drive mechanism functionally attached to a device to be rocked or glided;
an eccentric functionally rotably coupled to both said gear shaft and said drive mechanism translating rotary motion from the gear shaft when gear motor is powered to said drive mechanism, and said drive mechanism translating the motion to said device to be rocked or glided providing continuously smooth rocking or gliding motion to the device.

16. A motorized rocking or gliding apparatus, comprising:
a gear motor with a drive shaft;
linkage arms rotatably connected to a drive mechanism and to each other forming an actuating linkage to translate rotary motion of the gear motor to a reciprocating motion to provide a motorized rocking or gliding apparatus that when powered provides a powered, smooth, continuous, reciprocating rocking or gliding motion to an object to be rocked or glided.

17. The motorized rocking or gliding apparatus, as recited in claim 16, wherein said object to be rocked or glided is a wheelchair.

18. The motorized rocking or gliding apparatus, as recited in claim 16, wherein said motorized rocking or gliding apparatus is fixedly attached to a supporting base, said supporting base supplied with wheels ramps for said wheelchair.

19. The motorized rocking or gliding apparatus, as recited in claim 16, wherein said supporting base further provides a wheel support for the steering wheels of a wheelchair, said supporting base additionally having guide tracks containing roller bearings rotatably connected to said actuating linkage and to said wheel support to provide a smooth reciprocating motion to the wheelchair when the steering wheels of the wheelchair are supported by said wheel support.

20. The motorized rocking or gliding apparatus, as recited in claim 16, wherein said apparatus includes a footrest surface to support a user's feet.
